(19) United States
(12) Patent Application Publication
(10) Pub. No.: US 2015/0239360 A1
(43) Pub. Date: Aug. 27, 2015

(54) CHARGING PORTION FOR VEHICLE

(71) Applicants: Toyota Jidosha Kabushiki Kaisha, Toyota-shi Aichi-ken (JP); Sumitomo Wiring Systems, Ltd., Yokkaichi (JP)

(72) Inventors: Masaru Sasaki, Toyota-shi Aichi-ken (JP); Hiroyuki Yamazaki, Yokkaichi Mie (JP); Eiji Kitano, Toyota-shi Aichi-ken (JP)

(21) Appl. No.: 14/608,964

(22) Filed: Jan. 29, 2015

(30) Foreign Application Priority Data
Feb. 21, 2014 (JP) 2014-031993

(51) Int. Cl. B60L 11/18; H02J 7/00

(52) U.S. Cl. CPC B60L 11/1818; H02J 7/0045

(57) ABSTRACT

A charging portion for a vehicle is removably connected to a charging connector connected to an external power supply. The charging portion for a vehicle includes a lid box fixed to a body of the vehicle, an inlet provided to pass through the lid box, a terminal accommodated in the inlet, a wire connected to the terminal, and drawn from an end of the inlet located inside the vehicle, and a fixing member that fixes the wire to the end of the inlet. The wire is fixed to the end of the inlet using the fixing member.

This nonprovisional application is based on Japanese Patent Application No. 2014-031993 filed on Feb. 21, 2014, with the Japan Patent Office, the entire contents of which are hereby incorporated by reference.

### BACKGROUND OF THE INVENTION

1. Field of the Invention

The present invention relates to a charging portion for a vehicle removably connected to a charging connector, which is connected to an external power supply.

2. Description of the Background Art

In recent years, plug-in vehicles such as EVs (Electric Vehicles), PHVs (Plug-in Hybrid Vehicles) and the like have been developed which are equipped with a system for charging a power storage device with electric power supplied from an external power supply such as a charging stand or the like. In such a plug-in vehicle, the vehicle body is provided with a charging portion removably connected to a charging connector, which is connected to an external power supply.

For example, the charging portion for a vehicle disclosed in Japanese Patent Laying-Open No. 2012-243467 includes an attachment plate to be fixed to the vehicle body, an inner cylinder provided on the attachment plate to pass through the attachment plate, and an outer cylinder covering the entire outer circumference of the inner cylinder to protrude and be open toward the inside of the vehicle from the attachment plate. The inner cylinder is provided with terminal accommodating portions, in which a plurality of terminals are accommodated. Rear portions of the terminals are connected to wires, which are drawn from ends of the terminal accommodating portions located inside the vehicle.

### SUMMARY OF THE INVENTION

In a plug-in vehicle or the like, in general, AC electric power supplied through the charging portion for the vehicle is converted into DC electric power by a converter (not shown), and then stored in a power storage device. Thus, the charging portion and the converter of the vehicle are connected via wires.

The charging portion and the converter are arranged away from each other. For example, the converter is arranged in a spare tire accommodating portion or the like within the trunk room, and the charging portion is arranged at the rear of a side face of the vehicle, such as the rear fender or the like. Thus, the wires drawn from the terminal accommodating portions are routed over a considerable distance inside the vehicle to be connected to the converter. When the wires are connected to the converter, they are pulled closer to the converter, which may cause an excessive tensile force to exert on the terminals connected to the wires. In this case, the terminals may be inclined, making it impossible to connect the charging connector to the terminals.

Hence, in the structure disclosed in Japanese Patent Laying-Open No. 2012-243467, a front end of each terminal is inserted into an insertion hole in a partition provided within the terminal accommodating portion, and a forward stop located on the basal side of the front end is brought into abutment with the partition, so that forward movement is regulated. Further, a portion of the retainer fitted from the rear of the cylinders is brought into abutment with the forward stop, so that rearward movement is regulated. If, however, an excessive tensile force is exerted during the connection of the wires as described above, the state of abutment cannot be maintained, causing the terminals to be inclined. This results in a failure to connect the charging connector to the terminals during charging.

The present invention was made in view of the problem as described above, and an object of the invention is to provide a charging portion for a vehicle that allows a charging connector connected to an external power supply to be more securely connected.

A charging portion for a vehicle based on the present invention, which is removably connected to a charging connector connected to an external power supply, includes a lid box fixed to a body of the vehicle, an inlet provided to pass through the lid box, a terminal accommodated in the inlet, a wire connected to the terminal, and drawn from an end of the inlet located inside the vehicle, and a fixing member that fixes the wire to the end of the inlet. The wire is fixed to the end of the inlet using the fixing member.

By means of this structure, the wire drawn from the end of the inlet located inside the vehicle is fixed to the end of the inlet, so that when the wire is pulled to be connected to the converter, a tensile force exerted on the terminal and the side of the wire connected to the terminal can be alleviated. In this way, the terminal can be prevented from being inclined, and during charging, the charging connector connected to the external power supply can be more securely connected.

In the charging portion for a vehicle based on the present invention, the inlet may include an inlet housing and a covering member fixed to an end of the inlet housing. In this case, the covering member preferably allows the wire drawn from the end of the inlet housing to bend along the body of the vehicle.

As in the foregoing structure, allowing the wire to bend facilitates providing wide room for a trunk room and a passenger compartment arranged inside the vehicle. In the charging portion for a vehicle based on the present invention, the fixing member is preferably fixed to the covering member, and the covering member is preferably fixed to the inlet housing. Further, the inlet housing is preferably fixed to the lid box.

By means of this structure, the fixing member is fixed to the lid box via the inlet housing. Thus, even if the wire is pulled in the step of connecting the wire to a battery or the like, the terminal provided on the end of the wire can be prevented from being subjected to a tensile force. Thus, the problem of the terminal being inclined, for example, can be solved.

In the charging portion for a vehicle based on the present invention, the covering member preferably includes a displacement preventing portion for preventing displacement of the fixing member.

As in the foregoing structure, the fixing member can be stably fixed, and hence, the wire can be stably fixed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a charging portion for a vehicle according to an embodiment of the present invention;

FIG. 2 is a diagram showing the state in which wires are drawn from the inlet shown in FIG. 1, as seen from above the inlet;

FIG. 3 is a schematic cross-sectional view of the inlet shown in FIG. 1 as seen from a side; and

FIG. 4 is a schematic diagram showing the state in which the wires shown in FIG. 2 are fixed to an end of the inlet.

### DESCRIPTION OF THE PREFERRED EMBODIMENTS

Embodiments of the present invention will be described in detail below with reference to the drawings. In the following embodiments, the same or common elements in the drawings are indicated with the same reference numerals, and the description thereof will not repeated.

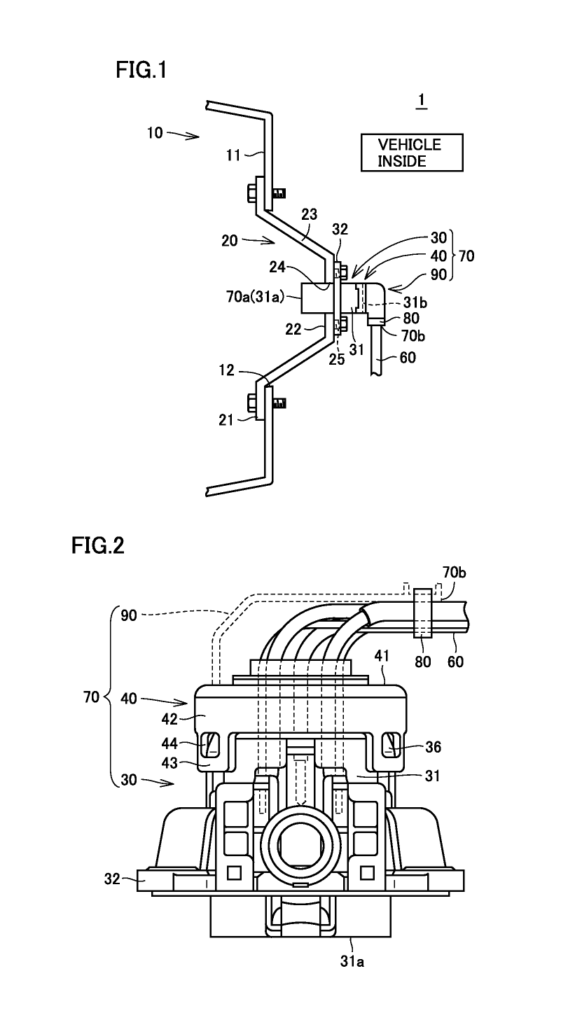

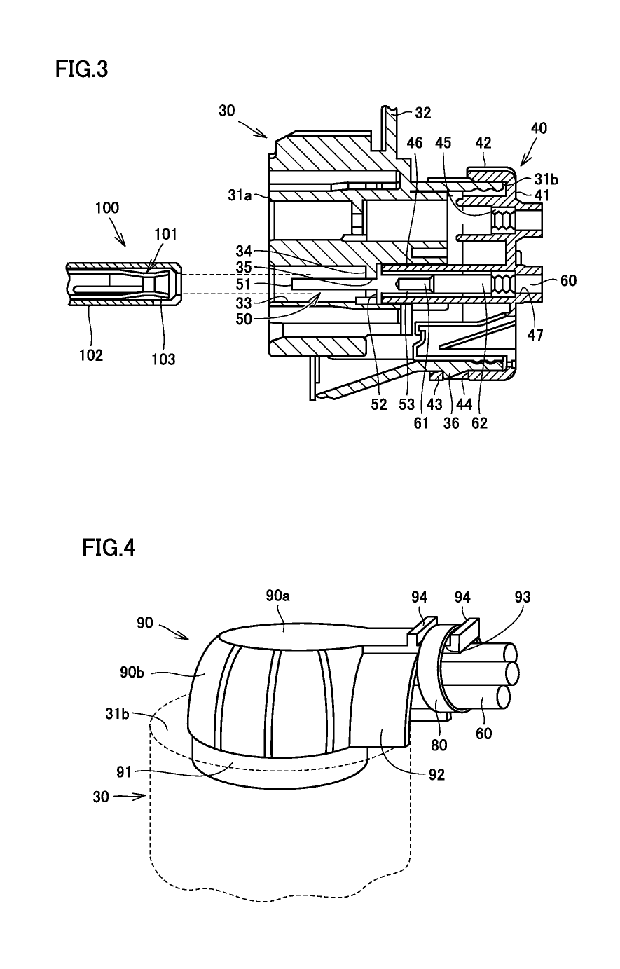

FIG. 1 is a schematic cross-sectional view showing a charging portion for a vehicle according to an embodiment of the present invention. FIG. 2 is a diagram showing the state in which wires are drawn from the inlet shown in FIG. 1, as seen from above the inlet. FIG. 3 is a schematic cross-sectional view of the inlet shown in FIG. 1 as seen from a side. FIG. 4 is a schematic diagram showing the state in which the wires shown in FIG. 2 are fixed to an end of the inlet. With reference to FIGS. 1 to 4, a charging portion 1 for a vehicle according to this embodiment will be described.

Charging portion 1 for a vehicle is removably connected to a charging connector located on a front end of a charging cable, which is connected to an external power supply (not shown), for charging a power storage device (not shown) of a plug-in vehicle such as an EV, a PHV, or the like. AC electric power supplied through charging portion 1 for a vehicle is converted into DC electric power by a converter (not shown), and then stored in the power storage device.

As shown in FIG. 1, charging portion 1 for a vehicle according to this embodiment includes a lid box 20, an inlet 70, a terminal 50 (see FIG. 3) accommodated in inlet 70, a wire 60 connected to terminal 50, and a tie band 80 serving as a fixing member.

Lid box 20 is attached to a depression 11 formed by a portion of a body 10 of the vehicle to be depressed toward the inside of the vehicle. Lid box 20 includes an attachment portion 21 attached to body 10 of the vehicle, a bottom 22, and a side wall 23 provided upright from bottom 22, and connecting bottom 22 and attachment portion 21.

Attachment portion 21 is arranged to abut on the vicinity of an opening 12 provided in depression 11 from the outside of the vehicle. Attachment portion 21 is a flange provided on an end of side wall 23 located opposite to bottom 22, and is attached to body 10 of the vehicle through a bolt inserted from the outside of the vehicle.

Bottom 22 is arranged inside body 10 of the vehicle (on the inside of the vehicle). Bottom 22 has a centrally provided opening 24, and a stud bolt 25 that protrudes toward the inside of the vehicle with lid box 20 being attached to body 10.

Side wall 23 is formed with a frame shape to surround a front end 70a of inlet 70 with a below-described inlet housing 30 being fixed to lid box 20. Space surrounded with side wall 23 and bottom 22 is open toward the outside of the vehicle. This allows the charging connector of the charging cable to be inserted into inlet 70 from the outside of the vehicle.

Inlet 70 includes inlet housing 30, a retainer 40, and a covering member 90. Inlet housing 30 has a body portion 31 provided to be capable of receiving the charging connector from the outside of the vehicle, a collar 32 located on a periphery of body portion 31, and a plurality of terminal accommodating portions 33 provided inside body portion 31 (see FIG. 3).

Body portion 31 has a substantially cylindrical shape. A front end 31a of body portion 31 is inserted into opening 24 of lid box 20, and is located within lid box 20. A rear end 31b of the body portion is located more inside the vehicle than bottom 22 of lid box 20. In this way, inlet 70 is provided to pass through lid box 20.

As shown in FIG. 2, body portion 31 has an engagement protrusion 36 that radially protrudes from an outer surface of body portion 31 located on rear end 31b. Engagement protrusion 36 is fitted into a below-described engagement groove 44 of the retainer, thereby fixing retainer 40 to inlet housing 30.

As shown in FIG. 3, terminal accommodating portion 33 accommodates terminal 50 connected to the charging connector of the charging cable. Terminal accommodating portion 33 has a partition 34 that divides the inside space into a front chamber located toward front end 31a of body portion 31 and a rear chamber located toward rear end 31b of body portion 31. Partition 34 is provided with a terminal insertion hole 35 for inserting a below-described terminal connection 51 of terminal 50 therethrough.

With reference again to FIG. 1, collar 32 has an insertion hole (not shown) provided in a position corresponding to the above-described stud bolt 25. Collar 32 is disposed to abut on bottom 22 of lid box 20 from the inside of the vehicle, and is fixed to lid box 20 with stud bolt 25 being inserted into the insertion hole.

With reference again to FIGS. 2 and 3, retainer 40 has a cylindrical shape with a closed end. Retainer 40 includes a bottom wall 41 and a peripheral wall 42 provided on a peripheral edge of bottom wall 41. Bottom wall 41 has a wire insertion hole 47 for passing wire 60 therethrough.

Wire insertion hole 47 is provided to extend along an axial direction of retainer 40, and pass through bottom wall 41. A plurality of ring-shaped lips 45 are arranged around an inner peripheral face of wire insertion hole 47. Bottom wall 41 is also provided with an insertion port (not shown) to allow insertion of a below-described insertion portion 91 of covering member 90 into rear end 31b of body portion 31.

Peripheral wall 42 is provided to cover an outer peripheral face of body portion 31 on rear end 31b. Peripheral wall 42 has a protrusion piece 43 that protrudes toward the axial direction of retainer 47. Protrusion piece 43 is provided with engagement groove 44 to be brought into engagement with engagement protrusion 36, which is provided on the outer surface of body portion 31.

Retainer 40 further includes a guide 46. Guide 46 is inserted into terminal accommodating portion 33 from rear end 31b of body portion 31, for guiding movement of retainer 40 when fitted. Guide 46 is preferably formed by at least a portion of wire insertion hole 47 extending along the axial direction.

Retainer 40 is fitted from rear end 31b of body portion 31, and engagement groove 44 is brought into engagement with engagement protrusion 36, so that retainer 40 is fixed to inlet housing 30. In this state, a below-described abutment portion 52 of terminal 50 is sandwiched between partition 34 and a front end of guide 46, which regulates movement of terminal 50 toward front end 31a and rear end 31b of body portion 31.

As shown in FIG. 4 (see also FIG. 2), covering member 90 is attached to rear end 31b of body portion 31, so as to cover at least wire insertion hole 47 in bottom wall 41 of retainer 40. Covering member 90 has a bottom 90a and a side peripheral face 90b, and has a cup shape having a substantially cylindrical shape with a closed end, which is formed such that a portion of side peripheral face 90b is open.

Covering member 90 includes insertion portion 91, a wire drawing port 92, a hook 93, and movement regulating means 94 serving as a displacement preventing portion for preventing displacement of the fixing member (tie band 80). Covering member 90 is configured to accommodate part of the plurality of wires 60, and guide the plurality of wires 60 toward wire drawing port 92.

Insertion portion 91 having an annular shape is provided on a front end of covering member 90 located opposite to bottom 90a on side peripheral face 90b. Insertion portion 91 is inserted into rear end 31b of body portion 31 through an insertion port (not shown) provided on bottom wall 41 of retainer 40. Covering member 90 is thus fixed onto body portion 31.

Wire drawing port 92 is a portion formed by providing an opening in a portion of side peripheral face 90b of covering member 90, as described above. Wire drawing port 92 is provided on an end 70b of inlet 70. The plurality of wires 60 are drawn from wire drawing port 92 toward the converter (not shown) inside the vehicle. Wire drawing port 92 may be provided to extend along a direction in which wires 60 are drawn.

Hook 93 is a part for hanging tie band 80. Hook 93 is connected to wire drawing port 92, and is provided to protrude along the direction in which the wires are drawn. In this embodiment, hook 93 is provided to protrude from bottom 90a of covering member 90 along the direction in which the wires are drawn.

Movement regulating means 94 is a part that regulates movement of tie band 80. Movement regulating means 94 is provided on opposite ends of hook 93 along the direction in which the wires are drawn. Movement regulating means 94 is made up of projections protruding toward an opposite direction to wires 60, from a main surface thereof located opposite to wires 60.

With reference again to FIG. 3, terminal 50, which is a male terminal, includes terminal connection 51, abutment portion 52, and a wire connection 53. Terminal 50 is formed by press-processing a conductive metal plate, for example.

Terminal connection 51 is located on a front end of terminal 50, and has a round bar shape. Terminal connection 51 is inserted from rear end 31b into terminal insertion hole 35 provided in partition 34 of terminal accommodating portion 33. Terminal connection 51 is a part electrically connected to a terminal portion 101 of charging connector 100 during charging.

Wire connection 53 has a substantially cylindrical shape open toward a rear end of terminal 50. Wire connection 53 is crimped with a hexagonal crimp, for example, onto a core wire 61 exposed through a coating member 62 on the front end of wire 60.

Abutment portion 52 is located between terminal connection 51 and wire connection 53. Abutment portion 52 is formed to be greater in width than terminal connection 51 and wire connection 53, and is formed to be capable of abutting on partition 34 from rear end 31b.

As shown in FIGS. 2 to 4, wire 60 includes core wire 61 and coating member 62 that coats core wire 61. Wire 60 is inserted from the rear end to pass through wire insertion hole 47 of retainer 40, with one end connected to terminal 50 being accommodated in terminal accommodating portion 33, and the other end being drawn from wire drawing port 92 located on end 70b of inlet 70.

Wires 60 drawn from wire drawing port 92 are bound with tie band 80 near wire drawing port 92. Tie band 80 tightens hook 93 and wires 60 while being partly wound around hook 93 to be located between movement regulating means 94.

Wires 60 are thus fixed to hook 93. The location of tie band 80 between movement regulating means 94 prevents removal of tie band 80 from hook 93, allowing wires 60 to be fixed stably. Wires 60 are connected to the converter (not shown) while being fixed to end 70b of inlet 70.

As shown in FIG. 3, at the time of charging, charging connector 100 is inserted into inlet 70 from the outside of the vehicle. Charging connector 100, which may be a female connector, for example, includes terminal portion 101 to be electrically connected to terminal connection 51, and an accommodating portion 102 that accommodates terminal portion 101. Accommodating portion 102 is located around terminal portion 101, and has a cylindrical shape. During charging, accommodating portion 102 enters between terminal 50 and terminal accommodating portion 33.

Terminal portion 101 has an inviting portion 103 for inviting terminal 50 toward the front end, and a contact (not shown) that is located toward the rear of inviting portion 103 (toward the external power supply), and can contact terminal 50.

Inviting portion 103 is formed to be greater in width than the contact and terminal 50, and can invite terminal 50 into an invitation region as shown by the dotted lines. During charging, when charging connector 100 is pushed forward into inlet 70, terminal 50 is guided into invitation region 103, causing terminal 50 to contact the contact.

Generally, if the front end of terminal 50 is accommodated in terminal accommodating portion 33 outside the above-mentioned invitation region, terminal 50 cannot be invited into terminal portion 101, which makes charging difficult. This circumstance is caused by an excessive tensile force being exerted on one end of wire 60 connected to the terminal, due to wire 60 being pulled closer to the converter when wire 60 is connected to the converter.

Although the movement of terminal 50 is regulated by abutment portion 52 of terminal 50 being sandwiched between partition 34 and the front end of guide 46 of retainer 40 as described above, if a tensile force above such a regulating force is exerted, retainer 40 may become loose, or wire 60 may become inclined within terminal accommodating portion 33, which causes terminal 50 to be inclined. As a result, terminal 50 will be placed outside the invitation region.

In charging portion 1 according to this embodiment, wires 60 are fixed to hook 93 of covering member 90 with tie band 80. Because of this structure of charging portion 1 in which wires 60 are fixed to end 70b of inlet 70 using the fixing member, a tensile force exerted on one end of wire 60 can be alleviated even if the wire is pulled closer to the converter to be connected to the converter.

This prevents exertion of a tensile force above the regulating force that regulates the movement of terminal 50 with abutment portion 52 of terminal 50 being sandwiched between partition 34 and the front end of guide 46 of retainer 40. As a result, terminal 50 can be prevented from being placed outside the invitation region of charging connector 100, so that during charging, charging connector 100 connected to the external power supply can be more securely connected.

Although the case where inlet 70 includes covering member 90 has been described by way of example in this embodiment, the invention is not limited thereto, and inlet 70 may not include covering member 90. In this case, a hook is provided on rear end 31b of inlet housing 30, and wires 60 are fixed to the hook using the fixing member. Further, although the case where tie band 80 is used as the fixing member has been described by way of example in this embodiment, the invention is not limited thereto, and tape or the like may be used.

Moreover, although the case where abutment portion 52 of terminal 50 is sandwiched between partition 34 and the front end of guide 46 of retainer 40 has been described by way of example in this embodiment, the invention is not limited thereto, and abutment portion 52 of terminal 50 may not be sandwiched between partition 34 and the front end of guide 46 of retainer 40. In this case also, wires 60 drawn from the end of inlet 70 are fixed to the end of inlet 70, which allows a tensile force to be alleviated. As a result, terminal 50 can be prevented from being inclined. Further, although the case where terminal 50 has a male terminal and charging connector 100 has a female terminal been described by way of example in this embodiment, the invention is not limited thereto, and terminal 50 may have a female terminal and the charging connector may have a male terminal.

While embodiments of the present invention have been described as above, it should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

What is claimed is:

1. A charging portion for a vehicle removably connected to a charging connector connected to an external power supply, comprising:
a lid box fixed to a body of said vehicle;
an inlet provided to pass through said lid box;
a terminal accommodated in said inlet;
a wire connected to said terminal, and drawn from an end of said inlet located inside said vehicle; and
a fixing member that fixes said wire to said end of said inlet,
said wire being fixed to said end of said inlet using said fixing member.

2. The charging portion for a vehicle according to claim 1, wherein
said inlet includes an inlet housing and a covering member fixed to an end of said inlet housing, and
said covering member allows said wire drawn from said end of said inlet housing to bend along said body of said vehicle.

3. The charging portion for a vehicle according to claim 2, wherein
said fixing member is fixed to said covering member, said covering member is fixed to said inlet housing, and said inlet housing is fixed to said lid box.

4. The charging portion for a vehicle according to claim 3, wherein
said covering member includes a displacement preventing portion for preventing displacement of said fixing member.
